(19) United States
(12) Patent Application Publication
(10) Pub. No.: US 2014/0173914 A1
(43) Pub. Date: Jun. 26, 2014

(54) CUTTER

(71) Applicant: Hsiu-Man YU CHEN, Taichung (TW)

(72) Inventor: Hsiu-Man YU CHEN, Taichung (TW)

(21) Appl. No.: 13/724,845

(22) Filed: Dec. 21, 2012

(51) Int. Cl. B26B 3/00

(52) U.S. Cl. CPC B26B 3/00
USPC 30/278

(57) ABSTRACT

A cutter includes a main body and a cutting unit. The main body is lengthwise defined to have a dispensing section, a holding section and a storage section in sequence. The holding section is gradually contracted toward two ends and defined to be a stop portion, and the storage section is bored with a through hole. The cutting section has one side formed with a pointed end and another side provided with a cutting edge. The main body is integrally covered on the cutting unit, leaving the pointed end and the cutting edge exposed and letting the pointed end located at a central upper edge of the dispensing section. By so designing, the cutter of this invention can easily cut off and remove various kinds of packaging members, able to elevate efficiency of removing packaging members from a packing box and integral in functional design.

### BACKGROUND OF THE INVENTION

1. Field of the Invention This invention relates to a cutter, particularly to one able to cut off and remove various kinds of packaging members and integral in functional design.

2. Description of the Prior Art

Generally, for facilitating articles to be carried and transported, the articles are frequently boxed or bagged for protection and, after the articles are packed in a box, the box has its butted seams sealed up by means of adhesive tapes or by staples and even the box itself is tied up by plastic packaging straps for insuring the articles to be kept intact in the box. For unsealing a packing box, a craft knife is often employed to cut off and remove every sort of packaging members fastened on the box and this method is unquestionable in point of technical level, but using the knife point to be a chief force-applying point of cutting will often cause injuries to the articles in the packing box. In addition, it is inconvenient to remove staples or plastic packaging straps from the packing box.

In view of the drawbacks mentioned above, a conventional cutter for enhancing efficiency of removing packaging members was disclosed in a US patent NO. D527604. This conventional cutter, referring to FIG. 1, is provided with a blade 1 having two ends respectively covered by a lug 2, 3, and a grip 4 extending lengthwise and having an upper portion covered on a central part of the cutter edge of the blade 1. Thus, when such a conventional cutter is used to cut off and remove various packaging members by means of the blade 1 between the grip 4 and the two lugs 2, 3, it avoids using the cutter point of the cutter to be a chief force-applying point of cutting, thus preventing the cutter point from damaging the articles in the box and elevating efficiency of removal of packaging members. Further, the grip 4 of the conventional cutter is bored with a through hole for hanging the cutter to facilitate storage of the cutter.

As mentioned above, the conventional cutter carries out cutting not by the cutter point but by the blade 1 between the grip 4 and the two lugs 2, 3; therefore, such a conventional cutter is unable to cut off packaging members that are seamless and completely and closely attached to the surfaces of a packing box.

### SUMMARY OF THE INVENTION

The objective of this invention is to offer a cutter for cutting off and removing various kinds of packaging members, integral in functional design and able to enhance efficiency of removing packaging members from a packing box.

The cutter in the present invention includes a main body and a cutting unit. The main body is lengthwise defined to have a dispensing section, a holding section and a storage section in sequence. The holding section is gradually contracted from its central portion toward two lengthwise ends and defined to be a stop portion, and the storage section is bored with a through hole. The cutting unit provided at the dispensing section has one side formed with a pointed end and another side provided with a cutting edge. The main body is integrally covered on the cutting unit, which at least reveals the pointed end and the cutting edge, letting the pointed end located at the central upper edge of the dispensing section.

The cutter of this invention is integrally covered by the main body except the cutting edge and the pointed end; therefore, when employed to cut and remove various packaging members, the cutter edge will not injure the articles in a packing box, and the pointed end is able to cut off packaging members that are seamless and have their edges closely attached on a packing box. By so designing, the cutter of this invention can easily and efficiently cut and remove all sorts of packaging members and further, the pointed end of the cutter can also be employed to pull up staples fastened on a packing box, having integrity in functional design. In addition, the cutter of this invention is provided with a stop portion for a user to press thereon so as to enhance stopping effect and increase force of application.

### BRIEF DESCRIPTION OF DRAWINGS

This invention will be better understood by referring to the accompanying drawings, wherein:

FIG. 1 is a perspective view of a conventional cutter;

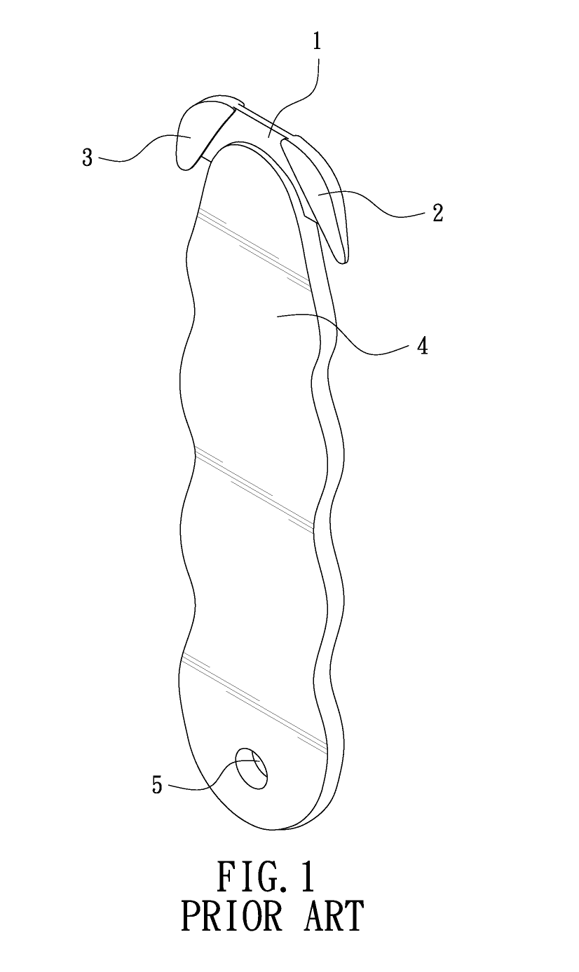

FIG. 2 is a perspective view of a cutter in the present invention;

FIG. 3 is a perspective view of a cutting unit of the cutter in the present invention;

FIG. 4 is a schematic view of the cutter in a first using condition in the present invention, illustrating that the cutter is employed to unseal a packing box in one way;

FIG. 5 is a schematic view of the cutter in a second using condition in the present invention, illustrating that the cutter is employed to unseal a packing box in another way;

FIG. 6 is a schematic view of the cutter in a third using condition in the present invention, illustrating that the cutter is employed to pull out staples and unseal a packing box in one way;

FIG. 7 is a schematic view of the cutter in a fourth using condition in the present invention, illustrating that the cutter is employed to pull out staples and unseal a box in another way;

FIG. 8 is a schematic view of the cutter in an operation condition in the present invention, showing a way of holding and operating the cutter; and

FIG. 9 is a schematic view of the cutter in an operation condition in the present invention, showing another way of holding and operating the cutter.

### DETAILED DESCRIPTION OF THE PREFERRED EMBODIMENT

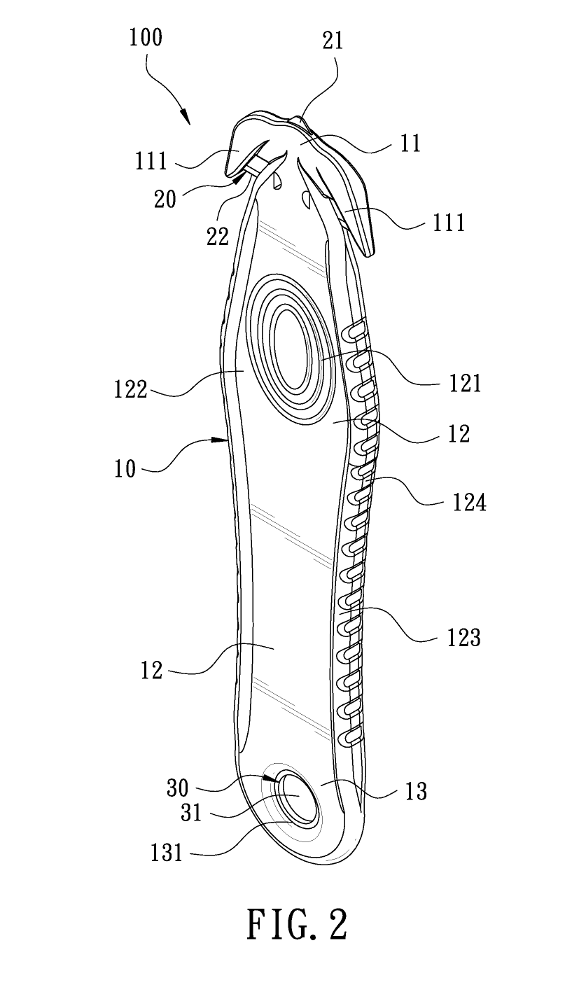

A preferred embodiment of a cutter 100 in the present invention, as shown in FIG. 2, includes a main body 10, a cutting unit 20 and a magnetic member 30 as main components combined together.

The main body 10 is a long plate body made of plastic, lengthwise defined to have a dispensing section 11, a holding section 12 and a storage section 13. The dispensing section 11 is gradually contracted toward the upper edge and has two sides respectively and integrally extending outward and downward to form a lug 111, having a gap with a downward opening formed between the dispensing section 11 and the two lugs 111. The holding section 12 has a front surface and a rear surface respectively provided with an anti-skid portion 121 composed of a plurality of concentric and oval-shaped convex rings. Further, the holding section 12 is gradually contracted from a central portion toward two lengthwise ends and defined to be a stop portion 122 and has the outer edges of two surfaces respectively disposed with a protruding stop edge 123 which is larger than the anti-skid portion 121 in thickness and has an outer side secured thereon with a plurality of anti-skid blocks 124. The storage section 13 is bored with a through hole 131.

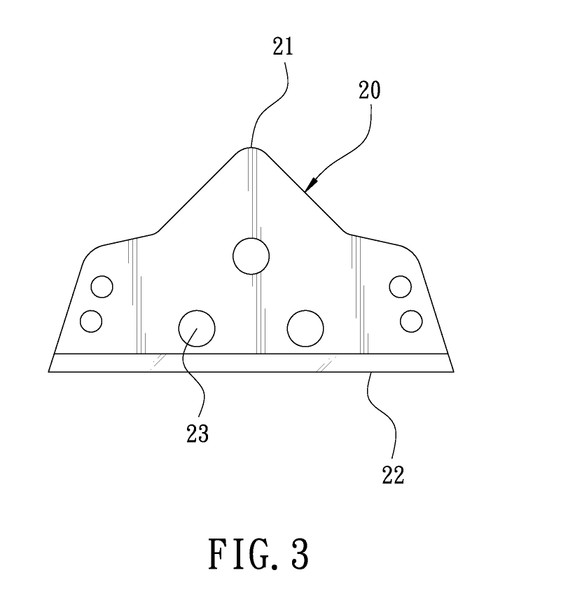

The cutting unit 20, referring to FIG. 3, is generally a triangular metal plate positioned at the dispensing section 11, having one side formed with a pointed end 21 and another side opposite to the pointed end 21 disposed with a cutting edge 22. The cutting unit 20 is bored with a plurality of insert holes 23, and the main body 10 is almost covered on the cutting unit 20, leaving the pointed end 21 and a part of the cutting edge 22 revealed. The pointed end 21 is located at a central portion of the upper edge of the dispensing section 11 while the cutting edge 22 is positioned at the gap formed between the dispensing section 11 and the two lugs 11.

The magnetic member 30 is an iron sheet installed at the storage section 13 and bored with an insert hole 31 at a location corresponding to the through hole 131, with the insert hole 31 communicating with the through hole 131. The magnetic member 30 is integrally covered by the main body 10, leaving an inner side edge exposed.

Referring to FIGS. 2 and 3, the main body 10 is integrally formed and covered on both the cutting unit 20 and the magnetic member 30 so the main body 10 can be produced with quickness and at low cost. Further, the dispensing section 11 of the cutter 100 is gradually contracted toward its upper edge and form with the pointed end 21, and the cutter edge 22 is respectively positioned between the dispensing section 11 and the two lugs 111 and thus, the cutter is to employ the cutter edge 22 to cut off various packaging members but not employ the cutter point to be a chief force-applying point of cutting, able to avoid damaging the articles in a packing box. Furthermore, when the main body 10 is integrally covered on the cutting unit 20, the insert holes 23 of the cutting unit 20 function to reinforce combination strength between the cutting unit 20 and the main body 10. One of the features of this invention is that the cutting unit 20 is triangle-shaped; therefore, when the pointed end 21 of the cutting unit 20 is operated to remove packaging members, stress of the pointed end 21 can be distributed evenly to enable the cutting unit 20 to bear a greater acting force.

Referring to Fig, 2, the holding section 12 has two surfaces respectively provided with an anti-skid portion 121 for preventing the cutter 100 from slipping off a user's hand when the user holds and employs the cutter 100. Additionally, the holding section 12 has the outer edges of the two surfaces respectively disposed with a protruding stop edge 123 with a thickness larger than that of the anti-skid portion 121. Thus, slipping between the cutter 100 and a user's hand can be avoided via both the anti-skid portions 121 and the stop edges 123. When using the cutter 100, a user can press and hold the stop portions 122 and the stop edge 123 to increase utility of applying force, and the anti-skid blocks 124 provided on the outer side of the stop edge 123 further function to prevent the cutter 100 from slipping off a user's hand.

In the preferred embodiment of this invention, the magnetic member 30 is an iron sheet with an exposed inner side edge, not only reinforcing the structure of the cutter 100 but also facilitating the cutter 100 to be picked up by magnet. The magnetic member 30 is bored with the insert hole 31 communicating with the through hole 131 of the storage section 13 for hanging the cutter 100 and facilitating storage of the cutter 100 by using magnet to attract the iron sheet.

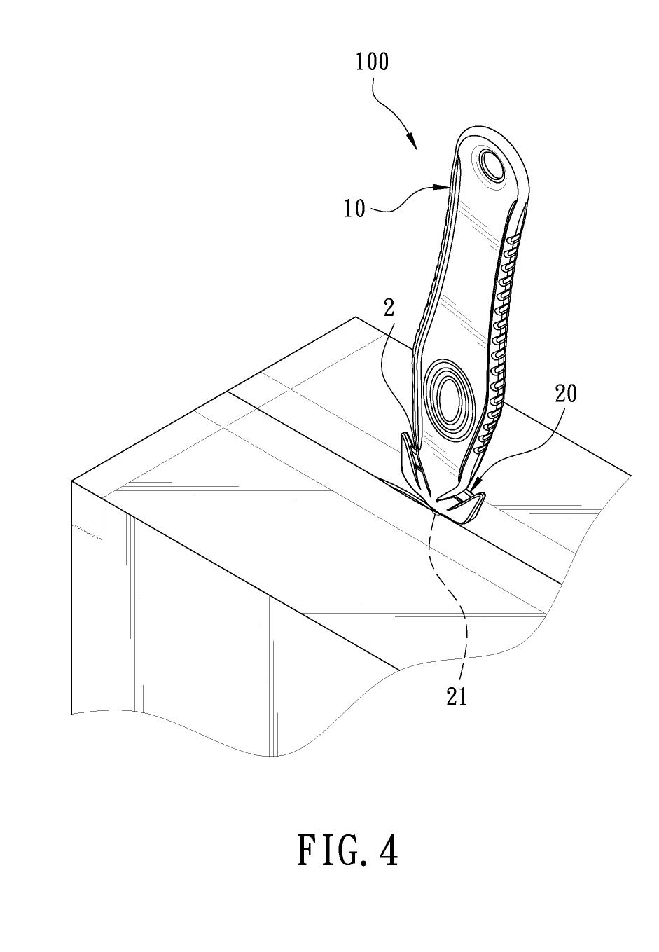

FIG. 4 shows a first using condition of the cutter 100 of this invention. Packaging members that are seamless and have their edges closely attached to a packing box can be cut off by the pointed end 21 of the cutter 100. Thus, the cutter 100 of this invention can easily cut and remove the packaging members that cannot be cut and removed by the cutter edge 22 of this invention.

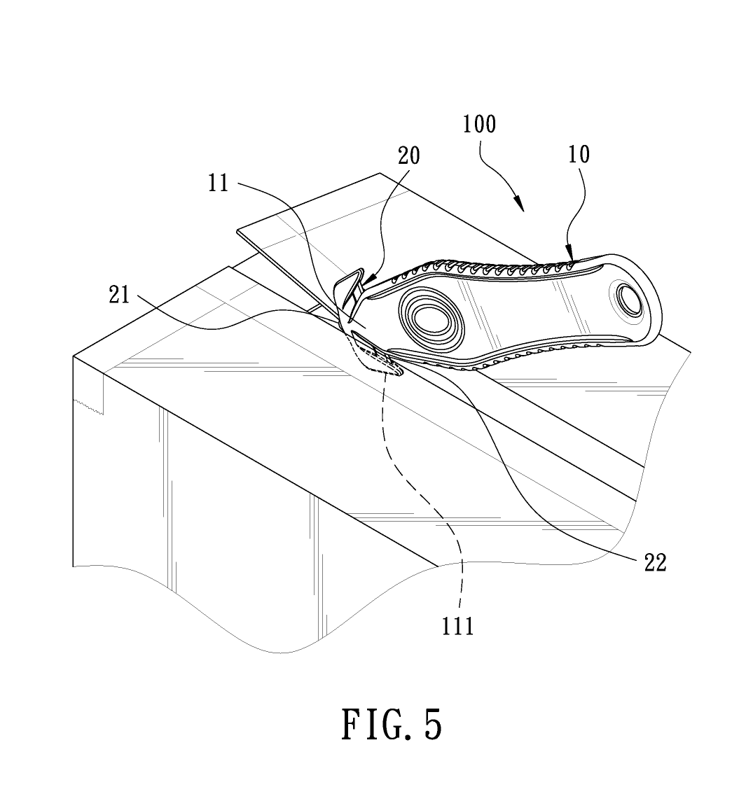

FIG. 5 shows a second using condition of the cutter 100 of this invention. The cutting unit 20 covered by the main body 10 has the exposed cutter edge 22 between the dispensing section 11 and the two lugs 111 carrying out cutting of packaging members without using the cutter point to be a chief force-applying point of cutting, avoiding causing injuries to the articles in a packing box and able to easily and efficiently cut and remove various packaging members, such as adhesive tapes and the like. Apart from being able to cut off all sorts of packaging members with easiness, the cutter edge 22 of the cutter 100 of this invention can also be employed to directly cut open a cardboard box without damaging the articles therein.

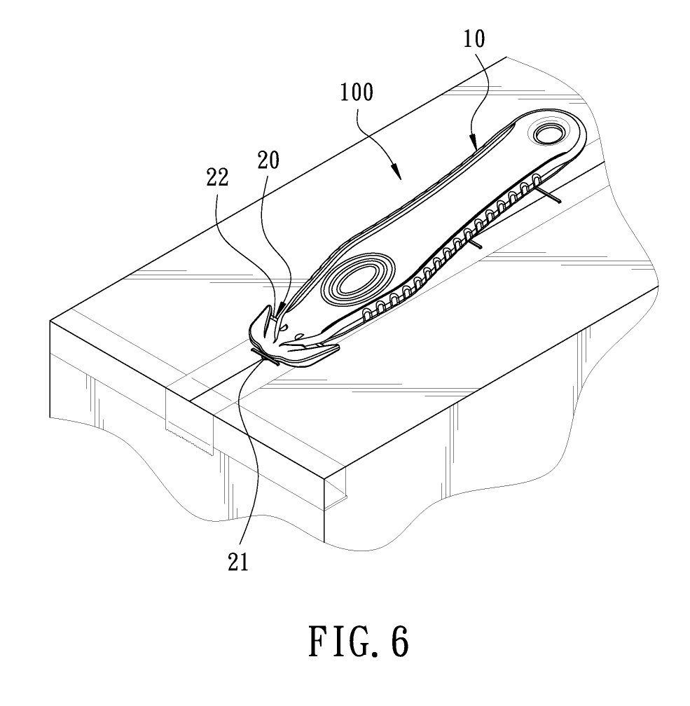

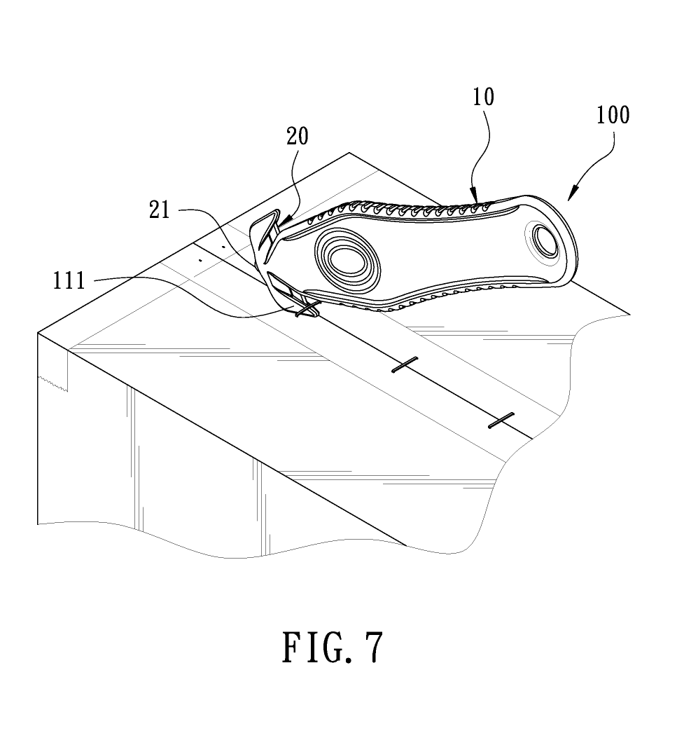

FIGS. 6 and 7 show a third and a fourth using conditions of the cutter 100 of this invention. The pointed end 21 of the cutter 100 can be used to pull up and remove staples from a packing box and, since the cutting unit 20 is triangle-shaped, when the pointed end 21 pulls up the staple of the box, the stress of the pointed end 21 can be dispersed to enable the cutting unit 20 to bear greater acting force. In addition, staples fastened on a packing box can also be pulled up by the lugs 111 cooperating with the pointed end 21 of the cutter 100, elevating efficiency of removing packaging members from a packing box.

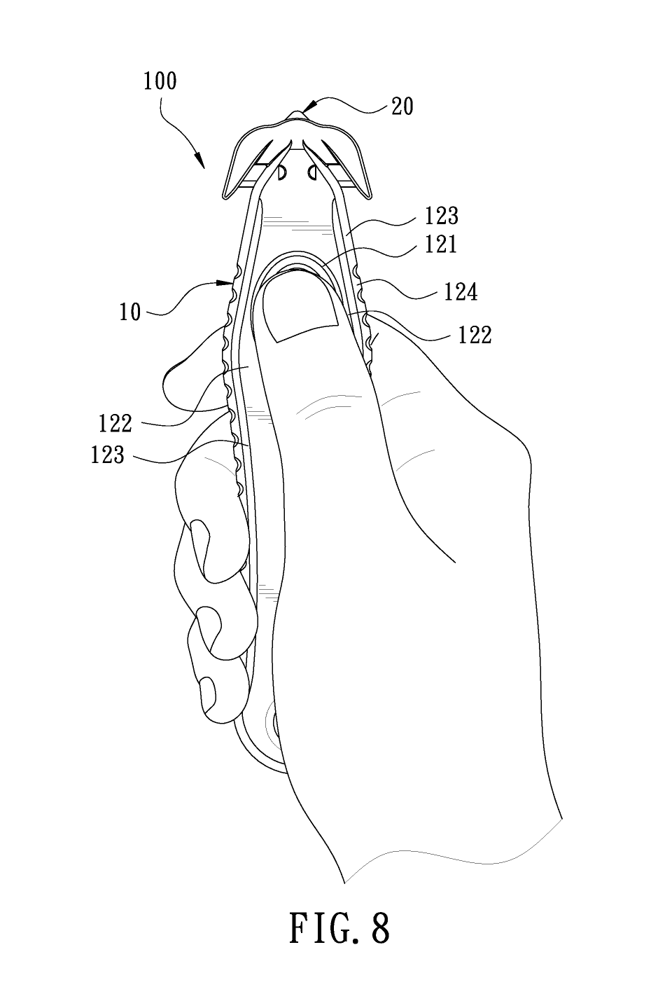

FIG. 8 shows a holding and operating condition of the cutter 100 of this invention. When holding and using the cutter 100, a user can press the anti-skid portions 121 of the cutter 100 to enhance stopping effect and increase force application, and the stop edge 123 provided at the outer side edge of the two surfaces of the holding section 12 further function to elevate stopping effect for avoiding slipping of the cutter 100 when a user holds and employs the cutter 100.

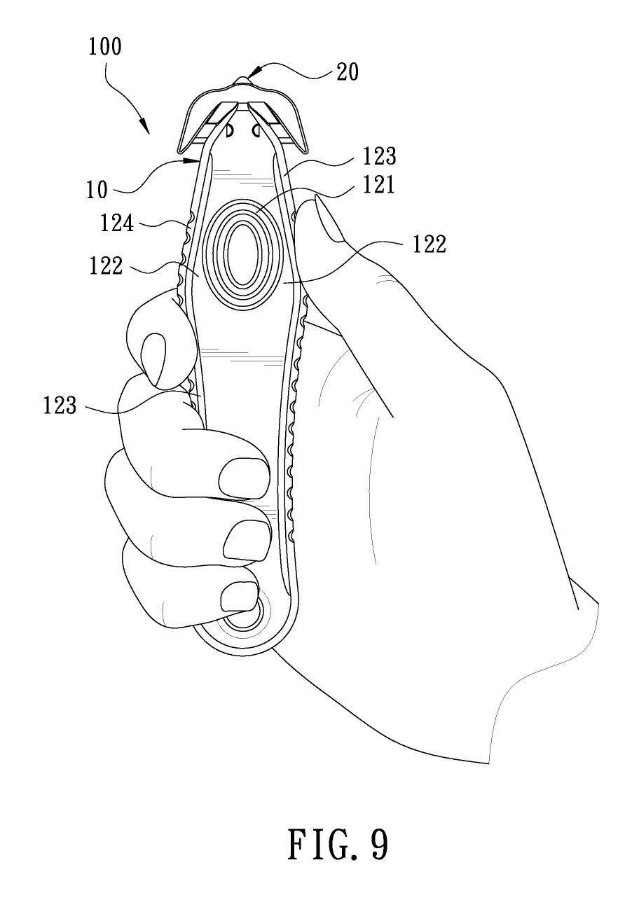

FIG. 9 shows another holding and operating condition of the cutter 100 of this invention. When holding and using the cutter 100, a user can press the stop portion 122 to force the lug 111 to pierce into a packaging member and have the cutter edge 22 removing the packaging member from a packing box, and the anti-skid blocks 124 on the outer side of the stop edges 123 can function to reinforce stopping effect for avoiding the cutter 100 slipping off a user's hand.

While the preferred embodiment of the invention has been described above, it will be recognized and understood that various modifications may be made therein and the appended claims are intended to cover all such modifications that may fall within the spirit and scope of the invention.

What is claimed is:

1. A cutter comprising:
a main body, said main body lengthwise defined to have a dispensing section, a holding section and a storage section in sequence, said holding section gradually contracted toward two ends and defined to be a stop portion, said storage section bored with a through hole; and
a cutting unit provided at said dispensing section, said cutting unit having one side formed with a pointed end and another side disposed with a cutter edge, said main body covered on said cutting unit, said cutting unit at least revealing said pointed end and said cutter edge, said pointed end positioned at a central upper edge of said dispensing section.

2. The cutter as claimed in claim 1, wherein said dispensing section is gradually contracted toward an upper edge.

3. The cutter as claimed in claim 1, wherein said dispensing section has two sides respectively and integrally extending outward to form a lug, a gap with a downward opening formed between said dispensing section and said lug, said cutter edge located in said gap.

4. The cutter as claimed in claim 1, wherein said holding section has two surfaces respectively provided with an anti-skid portion, said anti-skid portion composed of a plurality of convex rings, said convex rings being concentric and oval-shaped ones.

5. The cutter as claimed in claim 1, wherein said holding section has outer edges of a front surface and a rear surface respectively formed with a protruding stop edge, said stop edge having an outer side fixed thereon with a plurality of anti-skid blocks.

6. The cutter as claimed in claim 1, wherein said cutting unit is triangle-shaped and has one corner formed into said pointed end, said cutting unit provided with said cutter edge at an opposite side of said pointed end.

7. The cutter as claimed in claim 1, wherein said cutting unit is provided with a plurality of insert holes.

8. The cutter as claimed in claim 1, wherein a magnetic member is installed at said storage section, said magnetic member bored with an insert hole at a location corresponding to said through hole of said storage section, said insert hole communicating with said through hole.

9. The cutter as claimed in claim 8, wherein said magnetic member is an iron sheet.

10. The cutter as claimed in claim 8. wherein said main body is integrally covered on said magnetic member, said magnetic member revealing an inner side edge.
